(19) United States
(12) Patent Application Publication
(10) Pub. No.: US 2021/0146742 A1
(43) Pub. Date: May 20, 2021

(54) VEHICLE AND METHOD OF CONTROLLING THE SAME

(71) Applicants: HYUNDAI MOTOR COMPANY, Seoul (KR); KIA MOTORS CORPORATION, Seoul (KR); Industry-University Cooperation Foundation Hanyang University (IUCF-HYU), Seoul (KR)

(72) Inventors: WooSung LEE, Seoul (KR); Eun Woo NA, Suwon-si (KR); Kunsoo HUH, Seoul (KR); Jongwon PARK, Seoul (KR)

(73) Assignees: HYUNDAI MOTOR COMPANY, Seoul (KR); KIA MOTORS CORPORATION, Seoul (KR); Industry-University Cooperation Foundation Hanyang University (IUCF-HYU), Seoul (KR)

(21) Appl. No.: 16/832,925

(22) Filed: Mar. 27, 2020

(30) Foreign Application Priority Data
Nov. 19, 2019 (KR) 10-2019-0148764

(51) Int. Cl. B60G 17/0165; G06N 3/08

(52) U.S. Cl. CPC B60G 17/0165; G06N 3/08; B60G 2400/102; B60G 2400/204; B60G 2400/208; B60G 2400/82

(57) ABSTRACT

A method of controlling a vehicle is provided. The method includes: identifying detection signals output through a plurality of detectors during travel, identifying the detection signal that changes in response to a state of a road surface among the identified detection signals, acquiring detection information corresponding to the state of the road surface based on the detection signals, recognizing the state of the road surface based on detection information for each state of the road surface stored in a non transitory memory and the acquired detection information, and controlling the plurality of suspension devices based on the recognized state of the road surface and information regarding a control strategy of the suspension device for each state of the road surface stored in the storage.

### CROSS-REFERENCE TO RELATED APPLICATION

The present application claims priority to and the benefit of Korean Patent Application No. 10-2019-0148764, filed on Nov. 19, 2019, which is incorporated herein by reference in its entirety.

### TECHNICAL FIELD

The present disclosure relates to a vehicle and a method of controlling the same capable of controlling a damping force of a suspension device in response to a road surface condition.

### BACKGROUND

The statements in this section merely provide background information related to the present disclosure and may not constitute prior art.

A vehicle represents a machine that travels on a road by driving vehicle wheels, and the vehicle is equipped not only with electronic devices for travel but also with various devices for ensuring the safety of a driver and an occupant, protecting an occupant, assisting the drive, and improving the riding comfort.

The various devices include an airbag device for the driver's safety, such as drivers in the event of a vehicle collision, an electronic stability control (ESC) that controls the posture of the vehicle during acceleration or cornering of the vehicle, a traction control system (TCS), which controls the driving force of the vehicle when starting or accelerating the vehicle on a slippery road, such as on a snowy or rainy day, to prevent a tire from idling due to excessive driving force, an anti-lock brake system (ABS) that prevents wheels from being locked when the vehicle brakes suddenly, and a suspension device that supports the weight of the body by a spring action while buffering the vertical vibration of the wheels to improve riding comfort and prevent damage caused by an impact from a cargo while preventing excessive load from being applied to each part of the vehicle.

Among the devices, the suspension device is provided between a body side and each axle side, and primarily includes a shock absorber for absorbing a shock from a road surface, a spring, a suspension arm, and a suspension control device for variably controlling a damping force characteristic based on the shock absorber according to the road surface condition, and the like.

The vehicle includes a model for controlling the suspension device in response to the state of the road surface. The model is getting complex in controlling the suspension device as the degree of freedom is increased. On the other hand, when the model for controlling the suspension device is simplified, there is an error between the state of an actual vehicle and the state of a vehicle to be controlled through the simplified model.

### SUMMARY

The present disclosure provides a vehicle in which, among detection signals of a plurality of detectors, only detection signals having a change in response to a state of a road surface are processed, and the state of the road surface is recognized on the basis of the processed detection signals, and a method of controlling the same.

The present disclosure also provides a vehicle that updates information in a storage for recognizing a state of a road surface on the basis of detection information regarding a state of a road surface corresponding to detection signals, which is previously stored in the storage, and detection information regarding the states of a road surface corresponding to currently recognized detection signals.

Additional aspects of the disclosure will be set forth in part in the description which follows and, in part, will be obvious from the description, or may be learned by practice of the disclosure.

Therefore, it is an aspect of the disclosure to provide a vehicle comprising: a suspension device; a plurality of detectors configured to detect travel state information during travel and output detection signals related to the detected travel state information; a non transitory memory configured to store detection information and control information regarding a strategy of the suspension device for each state of a road surface; and a processor configured to acquire detection information regarding a state of the road surface on the basis of the detection signals output from the plurality of detectors, recognize the state of the road surface on the basis of the information stored in the non transitory memory and the acquired detection information, and control an operation of the suspension device on the basis of the recognized state of the road surface and the information stored in the non transitory memory.

The processor updates the information stored in the non transitory memory on the basis of the acquired detection information, the recognized state of the road surface, and information about controlling the suspension device.

In the recognizing of the state of the road surface, the processor identifies at least one detector having a detection signal that changes in response to the state of the road surface during travel among the plurality of detectors, and uses the detection signal detected by the identified at least one detector.

The at least one detector includes at least one of a speed detector for detecting a traveling speed, a plurality of wheel speed detectors provided on respective vehicle wheels including a left wheel and a right wheel at a front of a body and a left wheel and a right wheel at a rear of the body and each configured to detect a rotation speed of a corresponding one of the vehicle wheels, and a vertical acceleration detector configured to detector a vertical acceleration of the body.

The vehicle further comprises a chassis processor area network (CAN) communicator performing communication between the detector and the processor.

The processor recognizes the state of the road surface using deep learning, and recognizes the state of the road surface at preset time intervals.

The processor, if the recognized state of the road surface is determined to be a state of being paved, acquires a traveling speed on the basis of the detection signal output from the speed detector, and if the acquired traveling speed is less than or equal to a reference speed, performs soft control on the suspension device.

The processor, if the recognized state of the road surface is determined to be a state of being paved, acquires a traveling speed on the basis of the detection signal output from the speed detector, and if the acquired traveling speed is greater than a reference speed, performs hard control on the suspension device.

The processor, if the recognized state of the road surface is a state having a speed bump, performs soft control on the suspension device provided on the vehicle wheel that reaches the speed bump, and performs hard control on the suspension device provided on the vehicle wheel that has passed through the speed bump.

The processor, if the recognized state of the road surface is determined to be a state of being unpaved, performs soft control on each of the suspension devices provided on the plurality of vehicle wheels.

It is an aspect of the disclosure to provide a vehicle comprising: a plurality of vehicle wheels provided on respective sides of front, rear, left, and right of a body; a plurality of suspension devices each provided on a corresponding one of the plurality of vehicle wheels; a non transitory memory configured to store a deep learning program on the basis of a convolution neural network; a plurality of detectors configured to detect travel state information during travel and output a detection signal related to the detected travel state information; and a processor configured to identify a detection signal that changes in response to a state of a road surface among the detection signals output from the plurality of detectors, uses the identified detection signal as input data of the deep learning program to recognize the state of the road surface, and control the operation of the suspension device on the basis of the recognized state of the road surface.

The detection signal that changes in response to the state of the road surface includes at least one of a detection signal related to a traveling speed, a detection signal related to a rotation speed of the plurality of vehicle wheels, and a detection signal related to a vertical acceleration of the body.

The vehicle further comprises a chassis processor area network (CAN) communicator performing communication between the detector and the processor.

It is an aspect of the disclosure to provide a method of controlling a vehicle including a plurality of vehicle wheels provided on respective sides of front, rear, left, and right of a body and a plurality of suspension devices each provided on a corresponding one of the plurality of vehicle wheels, the method comprises: identifying detection signals output through a plurality of detectors during travel; identifying the detection signal that changes in response to a state of a road surface among the identified detection signals; processing the identified detection signals to acquire detection information corresponding to the state of the road surface; recognizing the state of the road surface on the basis of detection information for each state of the road surface stored in a non transitory memory and the acquired detection information; and individually controlling operations of the plurality of suspension devices on the basis of the recognized state of the road surface and information regarding a control strategy of the suspension device for each state of the road surface stored in the non transitory memory.

The acquiring of the detection information corresponding to the state of the road surface includes acquiring at least one of a detection signal related to a traveling speed, a detection signal related to a rotation speed of the plurality of vehicle wheels, and a detection signal related to a vertical acceleration of the body.

The individual controlling of the operations of the plurality of suspension devices includes: acquiring a traveling speed on the basis of the detection signal output from a speed detector if the recognized state of the road surface is determined to be a state of being paved; performing soft control on the suspension device if the acquired traveling speed is less than or equal to a reference speed; and performing hard control on the suspension device if the acquired traveling speed is greater than the reference speed.

The individual controlling of the operations of the plurality of suspension devices includes, if the recognized state of the road surface is a state having a speed bump: performing soft control on the suspension device provided on the vehicle wheel that reaches the speed bump; and performing hard control on the suspension device provided on the vehicle wheel that has passed through the speed bump.

The method comprises: if it is determined that the vehicle wheel having passed the speed bump is the front wheel, performing soft control on the suspension device provided on the rear wheel before the rear wheel reaches the speed bump.

The individual controlling of the operations of the plurality of suspension devices includes, if the recognized state of the road surface is determined to be a state of being unpaved, performing soft control on the suspension device.

The recognizing of the state of the road surface includes inputting the detection signal that changes in response to the state of the road surface as input data of a deep learning program based on a convolution neural network, to recognize the state of the road surface.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an exemplary view illustrating a suspension device provided in a vehicle in one form of the present disclosure.

FIG. 2 is a control block diagram illustrating a vehicle in one form of the present disclosure. FIG. 3 is a detailed block diagram illustrating a controller provided in a vehicle in one form of the present disclosure.

FIG. 4 is a detailed block diagram illustrating a road surface state recognizer in a controller provided in a vehicle in one form of the present disclosure.

FIG. 5 is a diagram illustrating a configuration of deep learning of a road surface state recognizer in a controller provided in a vehicle in one form of the present disclosure.

FIG. 6 is an exemplary diagram illustrating acquisition of a feature map when performing deep learning in a road surface state recognizer shown in FIG. 5.

FIG. 7 is a diagram illustrating acquisition of max pooling when performing deep learning in a road surface state recognizer shown in FIG. 5.

FIG. 8 is a control flowchart of a vehicle in one form of the present disclosure.

FIGS. 9, 10 and 11 are diagrams illustrating control of a suspension device of a vehicle in one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Like numerals refer to like elements throughout the specification. Not all elements of some forms of the present disclosure will be described, and description of what are commonly known in the art or what overlap each other in some forms of the present disclosure will be omitted. The terms as used throughout the specification, such as “˜part”, “˜module”, “˜member”, “˜block”, etc., may be implemented in software and/or hardware, and a plurality of “˜parts”, “˜modules”, “˜members”, or “˜blocks” may be implemented in a single element, or a single “˜part”, “˜module”, “˜member”, or “˜block” may include a plurality of elements.

It will be further understood that the term “connect” or its derivatives refer both to direct and indirect connection, and the indirect connection includes a connection over a wireless communication network.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements,

Although the terms “first,” “second,” “A,” “B,” etc. may be used to describe various components, the terms do not limit the corresponding components, but are used only for the purpose of distinguishing one component from another component.

As used herein, the singular forms “a,” “an” and “the” are intended to include the plural forms as well, unless the context clearly indicates otherwise.

Reference numerals used for method steps are just used for convenience of explanation, but not to limit an order of the steps. Thus, unless the context clearly dictates otherwise, the written order may be practiced otherwise.

Hereinafter, the operating principles and some forms of the present disclosure will be described with reference to the accompanying drawings.

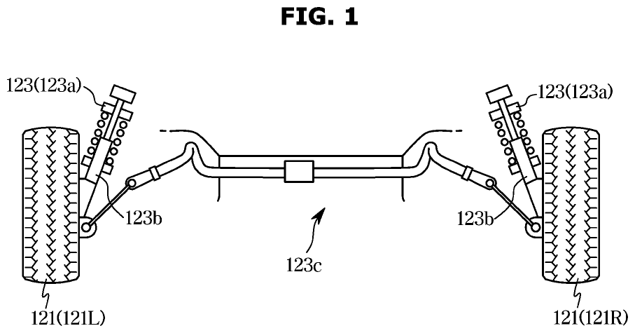

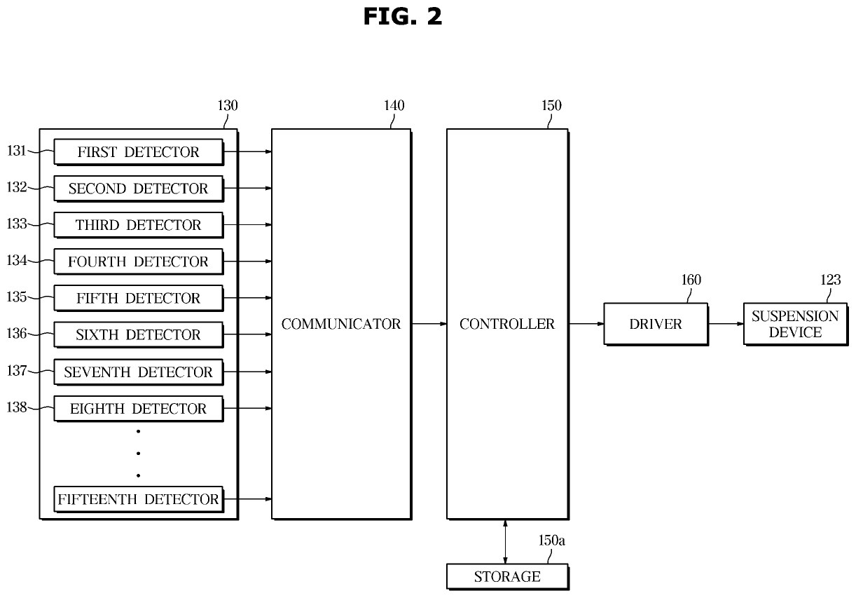

FIG. 1 is an exemplary view illustrating a suspension device provided in a vehicle 100 in some forms of the present disclosure.

The vehicle 100 includes a body having an interior and an exterior and a chassis, which is a part of the vehicle except for the body, on which mechanical devices required for traveling are installed.

The exterior of the body includes a front panel, a bonnet, a roof panel, a rear panel, front, rear, left and right doors, and window glasses provided on the front, rear, left, and right doors to enable opening and closing.

In addition, the exterior of the body includes a side mirror that provides the driver with a rear view, and a lamp that allows surrounding information to be easily recognized while looking forward and serves as signaling and communication with other vehicles and pedestrians.

The body of the vehicle may include a driver assistance system and various convenience devices for performing convenient functions.

The chassis of the vehicle refers to a frame for supporting the body, and includes front wheels 121 disposed adjacent to the front panel and the bonnet and disposed on respective sides of the left and the right of the body and rear wheels 122 disposed adjacent to the rear panel and disposed on respective sides of the left and the right of the body.

The chassis of the vehicle may include a power generation device for generating a driving force required for travel, a power transmission device for adjusting the generated driving force and applying the adjusted driving force to at least one pair of the front wheels 121 and the rear wheels 122, a steering device for adjusting the traveling direction of the vehicle, a braking device for applying a braking force to the wheels 121 and 122 on the front, rear, left, and right sides of the vehicle, and a suspension device 123 for preventing an impact of a road surface from being transmitted to the vehicle during travel.

The power generation device may include at least one of an engine, a cooling device, a lubrication device, an intake and exhaust device, a fuel device, and a charging device.

The power transmission device may include at least one of a clutch, a transmission, a propulsion shaft, a differential, an axle, and wheels.

The steering device may include at least one of a steering wheel, a steering gear, a link mechanism, and a pair of front wheels.

The braking device includes a service brake (e.g., a hydraulic brake) and may further include at least one of a parking brake and an auxiliary brake.

The suspension device 123 of the vehicle is a device that connects the axle to the body to control such that vibration or shock exerted on the axle during travel is not directly transmitted to the body to prevent damage to the body and cargo and improve ride comfort.

Referring to FIG. 1, the suspension device 123 includes a chassis spring 123a for mitigating an impact from a road surface and a shock absorber 123b for damping and controlling free vibration of the chassis spring 123a to improve ride comfort. Here, the shock absorber may be a shock absorber of an air suspension.

The suspension device 123 is a device for adjusting a roll stiffness value of the whole vehicle by adjusting the amount of torsion of a stabilizer bar using hydraulic pressure or a motor, and may further include a stabilization device 123c that controls a roll angle of the vehicle in a region where the lateral acceleration of the vehicle is small to improve the stability and ride comfort of the vehicle.

The stabilization device 123c may include a first roll stabilization device connected between the left and right front wheels 121L and 121R to adjust the vertical motion of the left and right front wheels 121L and 121R and a second roll stabilization device connected between the left and right rear wheels 122L and 122R to adjust the vertical motion of the left and right rear wheels 122L and 122R. Here, the structures of the first roll stabilizing device and the second roll stabilizing device may be the same as or similar to each other.

The power generation device, the power transmission device, the steering device, the braking device, and the suspension device forming the chassis of the vehicle perform a power generation operation, a power transmission operation, a steering operation, a braking operation, and a suspension operation on the basis of detection information detected by various detectors provided in the vehicle.

The vehicle may include an electronic control unit (ECU) for controlling the power generation device, the power transmission device, the steering device, the braking device, the suspension device, and the plurality of detectors. In this case, the ECU may be provided for each device, or may be provided as a single ECU that collectively controls the plurality of devices.

The vehicle includes a communicator for performing communication between various electronic devices therein. The communicator may perform at least one of wired communication and wireless communication. The communicator performing wired communication may perform controller area network (CAN) communication.

The communicator performing CAN communication may be a low-speed CAN communicator performing communication at a speed lower than or equal to a preset speed, and may be a high-speed CAN communicator performing communication at a speed exceeding the preset speed.

The low-speed CAN communicator includes a multimedia controller area network (M-CAN) communicator and a body controller area network (body CAN) communicator for transmitting and receiving signals for operating various electronic devices.

The high-speed CAN communicator includes a power train CAN (P-CAN) communicator and a chassis CAN (C-CAN) communicator that transmit and receive signals for real-time control of a power generation device, a power transmission device, a stability control (anti-lock braking system: ABS) and a shift function.

Here, the C-CAN communicator is used to transmit data at high speed as in a vehicle cluster (CLU), a yaw rate detector, an engine, a transmission, an ABS, an engine control unit (ECU), and a transmission control unit (TCU), and has a communication speed of about 500 kbps.

The various devices of the chassis 120 in some forms of the present disclosure may communicate with a plurality of detectors through the C-CAN communicator and receive detection information detected by the plurality of detectors.

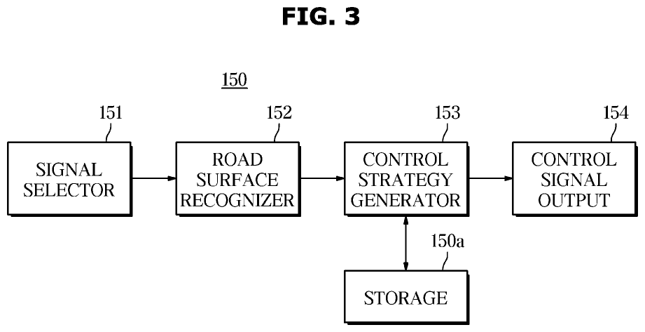

FIG. 2 is a control block diagram illustrating the vehicle 100 in some forms of the present disclosure.

The vehicle 100 includes a suspension device 123, a detection device 130, a communicator 140, a controller 150, a storage 150a, and a driver 160.

The suspension device 123 is provided between the body and the wheels to support the body. Such a suspension device may be provided on the left and right wheels at the front of the body and the left and right wheels at the rear of the body. That is, a total of four units of the suspension device may be provided.

Each suspension includes a spring provided between the body and the wheel, and a shock absorber for adjusting a damping force (see FIG. 1). Here, the shock absorber may include a hydraulic damper or air damper for adjusting the damping force, and may further include an actuator for adjusting the damping force characteristic to a hard characteristic or soft characteristic. Here, the actuator may be a valve.

The hard characteristic represents generating a damping force that is larger than a damping force generated by soft characteristic, when the shock absorber is extended and contracted at the same relative speed.

The actuator adjusts a damping force generation position of the shock absorber by adjusting current in response to a control command of the controller 150.

The suspension devices connected to the respective sides of a pair of wheels (i.e., the front wheels) provided at the front of the body may be controlled with the same damping force. In addition, the suspension devices connected to the respective sides of a pair of wheels (i.e., the rear wheels) provided at the rear of the body may be controlled with the same damping force. In this case, the suspension device of the front wheels may be controlled with a damping force different from a damping force of the suspension device connected to the rear wheels.

In addition, the suspension devices connected to the respective sides of the left front wheel and the right front wheel may also be controlled with different damping forces, and the suspension devices connected to the respective sides of the left rear wheel and the right rear wheel may also be controlled with different damping forces.

The suspension device may be an electronically controlled suspension device for controlling the damping force of the shock absorber when the shock absorber is extended and compressed against the vertical swing of the body.

The suspension device may be any one of a passive type suspension device, an active type suspension device, and a semi-active suspension device.

The detection device 130 detects various types of information generated from traveling characteristics of the vehicle during travel and outputs a detection signal corresponding to the detected information. For example, the traveling characteristics may include a traveling speed, a wheel speed, up, down, left and right movements, acceleration, deceleration, braking, steering, and the like.

The detection device 130 may be provided on the chassis. Such a traveling characteristic may be a characteristic corresponding to the state of the chassis during travel.

The detection device 130 may include a plurality of detectors for detecting various types of information generated by the traveling characteristics.

The detection device 130 includes a first detector 131 that detects a traveling speed of the vehicle.

The detection device 130 includes a second detector 132 for detecting the wheel speed of the wheel provided on the left side of the front of the body, a third detector 133 for detecting the wheel speed of the wheel provided on the right side of the front of the body, a fourth detector 134 for detecting the wheel speed of the wheel provided on the left side of the rear of the body, and a fifth detector 135 for detecting the wheel speed of the wheel provided on the right side of the rear of the body.

The detection device 130 may include, as a detector for detecting the vertical acceleration of the body, a sixth detector 136 provided on the left wheel of the front of the body and detecting the vertical acceleration of the front left side of the body, a seventh detector 137 provided on the right wheel of the front of the body and detecting the vertical acceleration of the front right side of the body, and an eighth detector 138 provided on the right wheel of the rear of the body and detecting the vertical acceleration of the rear right side of the body.

The sixth, seventh, and eighth detectors detect the acceleration (acceleration on the spring of the suspension device) of the up-down direction with respect to absolute coordinate systems of the front left, front right, and rear right sides of the body.

The accelerations in the up and down directions may be vibration accelerations in the up and down directions of the vehicle during travel of the vehicle.

The detection device 130 may include, as a detector for detecting the vertical acceleration of the wheels, a ninth detector provided on the left wheel of the front of the body and detecting the vertical acceleration of the front left wheel of the body, and a tenth detector provided on the right wheel of the front of the body and detecting the vertical acceleration of the front right wheel of the body.

The detection apparatus 130 detects an eleventh detector for detecting the lateral acceleration of the vehicle, a twelfth detector for detecting the longitudinal acceleration of the vehicle, a thirteenth detector for detecting the steering angle of the steering wheel, a fourteenth detector for detecting the steering angular velocity of the steering wheel, and a fifteenth detector for detecting the yaw rate of the vehicle.

The various detectors provided in the vehicle may be electrically and mechanically connected to the controller 150. The various detectors provided in the vehicle may transmit and receive various types of information to and from the controller 150 through the communicator 140 provided in the vehicle.

The communicator 140 may include at least one component that enables communication between internal components in the vehicle, for example, at least one of a short-range communication module, a wired communication module, and a wireless communication module.

The short-range communication module may include various short-range communication modules that transmit and receive signals using a wireless communication network in a short range, such as a Bluetooth module, an infrared communication module, a radio frequency identification (RFID) communication module, a wireless local access network (WLAN) communication module, an NFC communication module, and a zigbee communication module.

The wired communication module may include various wired communication modules, such as a controller area network (CAN) communication module, a local area network (LAN) module, a wide area network (WAN) module, or a value added network communication (VAN) module, and various cable communication modules, such as a universal serial bus (USB) module, a high definition multimedia interface (HDMI) module a digital visual interface (DVI) module, a recommended standard-232 (RS-232) module, a power line communication module, or a plain old telephone service (POTS) module.

The wired communication module may further include a local interconnect network (LIN).

The CAN communication module may include a chassis CAN communicator that transmits data at a high speed, in a cluster of a vehicle (CLU), an engine, a transmission, an engine control unit (ECU), and a transmission control unit (TCU). That is, the chassis CAN communicator transmits the detection signals detected by the plurality of detectors of the detection device 130 to the controller 150.

The wireless communication module may include wireless communication modules supporting various wireless communication methods, such as a Wifi module, a wireless broadband module (Wibro) module, a global system for mobile communication (GSM) module, a code division multiple access (CDMA) module, a wideband code division multiple access (WCDMA) module, a universal mobile telecommunications system (UMTS) module, a time division multiple access (TDMA) module, a long term evolution (LTE) module, and the like.

The controller 150 identifies detection signals that change in response to the state of the road surface while traveling among the detection signals detected by the plurality of detectors, acquires detection information regarding the state of the road surface on the basis of the detected detection signals, and recognizes the state of the road state on the basis of information stored in the storage 150a and the acquired detection information.

When the controller 150 identifies detection signals that change in response to the road surface during travel, the controller 150 may identify a detection signal corresponding to detection of a traveling speed of the vehicle, a detection signal corresponding to detection of a rotational speed of each wheel, and a detection signal corresponding to detection of a vertical acceleration of the body.

That is, the controller 150 identifies detection signals output from the first detector, the second detector, the third detector, the fourth detector, the fifth detector, the sixth detector, and the eighth detector. Accordingly, the data capacity and the calculation amount for information stored in the storage may be reduced.

The controller 150 identifies detection signals output from the first detector, the second detector, the third detector, the fourth detector, the fifth detector, the sixth detector, and the eighth detector at preset time intervals, and recognizes the state of the road surface at the preset intervals. The preset time interval may be approximately 10 ms.

The controller 150 may store information about the identified detection signals in the storage 150a, and also store operation information about the suspension device being controlled in response to the recognized state of the road surface. That is, the controller 150 may update the information stored in the storage 150a and use the updated information as information for controlling the suspension device at a later time.

In addition, the information stored in the storage 150a may be information previously acquired by experiments.

The controller 150 may control the operation of the suspension device 123 to adjust the damping force (that is, the attenuation force) on the basis of the recognized state of the road surface and information about a control strategy of the suspension device for each state of the road surface stored in the storage.

That is, the controller 150 controls the suspension device 123 such that the damping force of the shock absorber is reduced if it is determined that the road surface is in a state of being irregular or having a speed bump, and controls the suspension device 123 such that the damping force of the suspension is increased if it is determined that the road surface is in a state of being regular.

The state of a road surface being irregular may be a state of being unpaved or having a speed bump.

The state of a road surface being regular may be a state of being paved.

The controlling to reduce the damping force includes performing soft control on the shock absorber and reducing a target current value of the actuator of the shock absorber.

The controlling to increase the damping force includes performing hard control on the shock absorber and increasing a target current value of the actuator of the shock absorber.

The controller 150 may individually control the current flowing through the shock absorbers connected to the front, rear, left, and right wheels.

The controller 150 may control the current flowing through the shock absorbers connected to the front left and right wheels to be equal, and control the current flowing through the shock absorbers connected to the rear left and right wheels to be equal, while the current flowing through the pair of front wheels is different from the current flowing through the pair of rear wheels.

The controller 150 may control the current flowing through the shock absorbers connected to the front left wheel and the rear left wheel to be equal, and control the current flowing through the shock absorbers connected to the front right wheel and the rear right wheel to be equal while the current flowing through the wheels provided on the left side of the body is different from the current flowing through the wheels provided on the right side of the body.

If it is determined that the recognized state of the road surface is a state of being paved, the controller 150 acquires the traveling speed of the vehicle on the basis of the detection signal output from the first detector. If the acquired traveling speed is less than or equal to a reference speed, the controller 150 performs soft control on the suspension devices provided on the front, rear, left, and right wheels of the body, and if the acquired traveling speed is greater than the reference speed, the controller 150 performs hard control on the suspension devices provided on the front, rear, left, and right wheels of the body.

If it is determined that the recognized state of the road surface is a state of being unpaved, the controller 150 performs soft control on the suspension devices provided on the front, rear, left, and right wheels of the body.

If it is determined that the recognized state of the road surface is a state of having a speed bump, the controller 150 controls the suspension devices provided on the left and right wheels of the front of the body (i.e., the front wheels) with a damping force different from a damping force of the suspension devices provided on the left and right wheels of the rear of the body (i.e., the rear wheels). The controller 150 controls the respective suspension devices with different damping forces in response to the positions of the front wheels, the rear wheels, and the speed bump.

The controller 150 may perform soft control on the suspension devices from the point in time at which the front wheels and the rear wheels reach the speed bump until the point in time at which the front wheels and the rear wheels are passing through the speed bump, and perform hard control on the suspension device after the front wheels and the rear wheels pass through the speed bump.

In the performing of hard or soft control on each suspension device, the controller 150 may control the current flowing through the shock absorber of each suspension device.

The controller 150 may acquire a target current value of each actuator on the basis of a map stored in the storage 150a, and output a control signal corresponding to the acquired target current value of each actuator to each actuator. Accordingly, the shock absorber of each suspension device may variably change the damping force characteristics.

The controller 150 may be divided into a plurality of components that perform respective functions performed by the controller 150.

Referring to FIG. 3, the controller 150 may include a detection signal selector 151 for selecting only a detection signal for recognizing the state of a road surface among a plurality of detection signals, a road surface state recognizer 152 for recognizing the state of a road surface on the basis of the selected detection signal, a control strategy generator 153 for generating a control strategy for controlling the suspension device on the basis of information regarding the state of the road surface recognized by the road surface state recognizer 152 and the information stored in the storage, and a control signal output 154 for storing the control strategy generated by the control strategy generator 153 together with the detection signal and the information regarding the road surface state, and outputting a control signal corresponding to the generated control strategy to the actuator.

Since the units for the detection signals are different from each other, the detection signal selector 151 may perform normalization control to unify the units of the detection signals. That is, the detection signal selector 151 may perform signal processing on the detection signals.

The detector having a detection signal that changes in response to the state of the road surface may be a predetermined detector, or may be a detector having a detection signal that changes in response to a change in roll moment and pitch moment of the vehicle.

The road surface state recognizer 152 may recognize the state of the road surface using deep learning. This will be described below.

As such, the configuration of the controller 150 may be embodied as the detection signal selector 151, the road surface state recognizer 152, the control strategy generator 153, and the control signal output 154.

At least one component may be added or omitted to correspond to the performances of the components of the controller shown in FIG. 3. In addition, the mutual positions of the components may be changed to correspond to the performance or structure of the system.

Some of the components shown in FIG. 3 may refer to a software component and/or a hardware component, such as a Field Programmable Gate Array (FPGA) and an Application Specific Integrated Circuit (ASIC).

The controller 150 may be implemented as a single processor.

The controller 150 may include a memory (not shown) for storing data regarding an algorithm for controlling the operations of the components of the vehicle or a program that represents the algorithm, and a processor (not shown) that performs the above described operations using the data stored in the memory. At this time, the memory and the processor may be implemented as separate chips. Alternatively, the memory and the processor may be implemented as a single chip.

The storage 150a stores the detection information for each state of the road surface and information regarding the control strategy of the suspension device for each state of the road surface. The information regarding the control strategy of the suspension device may include map information in which a target current value transmitted to the shock absorber of each of the plurality of suspension devices is matched with a corresponding state of the road surface.

The state of the road surface may include a state in which the road surface is regular and a state in which the road surface is irregular.

The state of the road surface being regular may include a state of being paved. The state of the road surface being irregular may include a state of being unpaved or a state of having a speed bump or a port hole.

The storage 150a may store a deep learning program based on a convolutional neural network (CNN).

The storage 150a may include a nonvolatile memory device, such as a cache, a read only memory (ROM), a programmable ROM (PROM), an erasable programmable ROM (EPROM), an electrically erasable programmable ROM (EEPROM), and a flash memory, a volatile memory device, such as a random access memory (RAM), or other storage media, such as a hard disk drive (HDD), a CD-ROM, and the like, but the implementation of the storage 150a is not limited thereto.

The storage 150a may be a memory implemented as a chip separated from the processor, which will be described below in connection with the controller 150, or may be implemented as a single chip integrated with the processor.

The driver 160 drives the shock absorber of the suspension device in response to the control command of the controller 150. The driver 160 may include an actuator of the shock absorber.

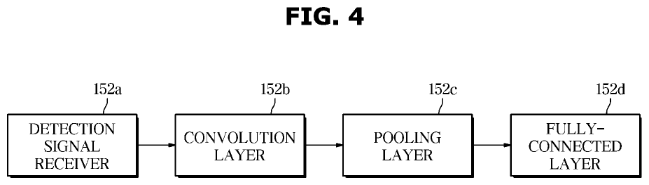

Referring to FIG. 4, the road surface state recognizer 152 may perform deep learning using a CNN.

The CNN may include a detection signal receiver 152a, a convolution layer 152b, a pooling layer 152c, and a fully connected layer 152d.

The detection signal receiver 152a may receive only a detection signal for recognizing the state of a road surface among detection signals output from the plurality of detectors.

The detection signal receiver 152a may determine a detector that outputs a detection signal required for recognizing the state of the road surface by performing deep learning through a CNN, and receive only a detection signal output from the determined detector.

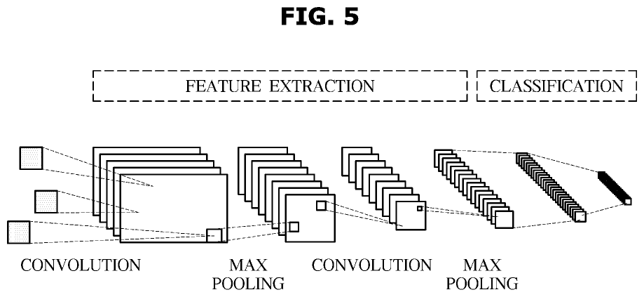

Referring to FIG. 5, the convolution layer and the pooling layer may have a structure in which stacks are repeatedly layered, and may refer to a feature extractor for extracting features from detection signals.

In more detail, the convolution layer 152b extracts feature information regarding the received detection signals.

The convolution layer 152b may include a filter for extracting feature information from data corresponding to the detection signals, and an activation function for converting a value of the filter into a nonlinear value.

The filter may refer to a function for detecting the existence of a detection signal that is characteristic among the received detection signals. Such a filter may be defined as a square matrix, such as (3, 3), (4, 4) or (5, 5).

The filter outputs a large resultant value in response to a presence of feature information in the data corresponding to the received detection signal, and outputs a value close to zero in response to an absence of feature information or similar feature information.

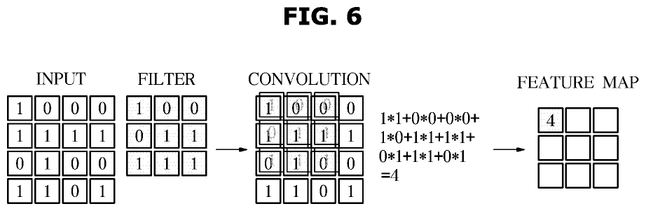

Referring to FIG. 6, in the case of 5×5 data, the convolution layer 152b shifts the 3×3 filter one pixel at a time from the top left to the right, and in the next row, shifts the 3×3 filter one pixel at a time to the left to thereby extract feature information. In this case, the pixel values of the original image in which the 3×3 filter is located are multiplied.

As such, the convolution layer 152b may acquire a feature map by applying a filter to data. The feature map is referred to as an activation map.

The size of the feature map is determined according to the size of data, the size of a filter, and the size of a stride. Here, the stride refers to the number of columns and rows by which the filter is shifted.

The convolution layer 152b may pass only detection information that is characteristic in each data.

The pooling layer 152c performs an operation of reducing the extracted feature map. Pooling of the pooling layer may include max pooling, average pooling, and L2-norm pooling.

The pooling layer 152c in some forms of the present disclosure performs an operation of reducing the extracted feature map using max pooling.

Max pooling represents cutting the feature map to a size M×N and then selecting the largest value in the feature map.

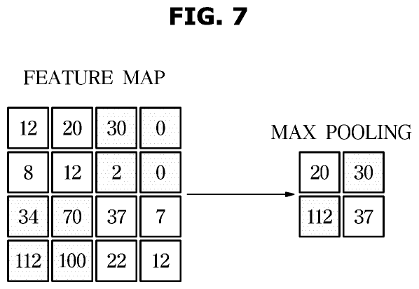

Referring to FIG. 7, the pooling layer 152c shifts a 2×2 max pooling filter in a 4×4 feature map with a stride of 2 and selects a maximum value, to acquire a max pooling.

The pooling layer 152c receives output data of the convolution layer as an input and reduces the size of data of the feature map or emphasizes specific data. With such a configuration, the size of the entire data is reduced so that computational resources associated with computation are reduced.

The convolutional layer uses a filter to find a feature of an image while minimizing the number of shared data, while the pooling layer enhances and collect the feature.

The fully-connected layer 152d may include a hidden layer and an output layer composed of approximately 1024 neurons.

The fully-connected layer 152d applies the feature information to the neural network, performs classification on the received detection signal, and outputs information regarding the state of the road surface in response to the classification. For example, the fully-connected layer may convert pieces of feature information into constant values using the Softmax function. The sum of the converted values becomes 1, and the highest value is a target of classification.

As such, the road surface state recognizer 152 may recognize the state of the road surface by performing deep learning on the received detection signals.

The recognition of the state of the road surface may be performed at preset intervals.

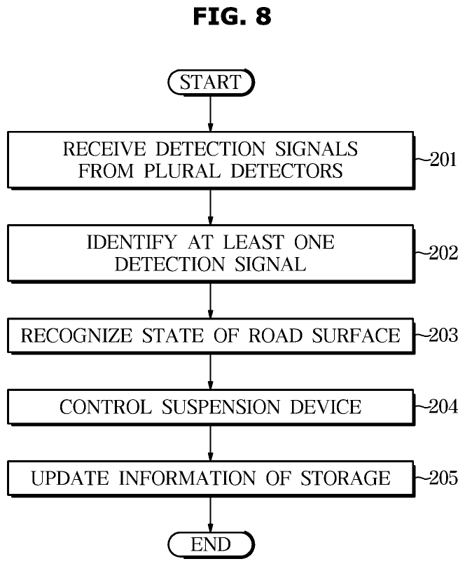

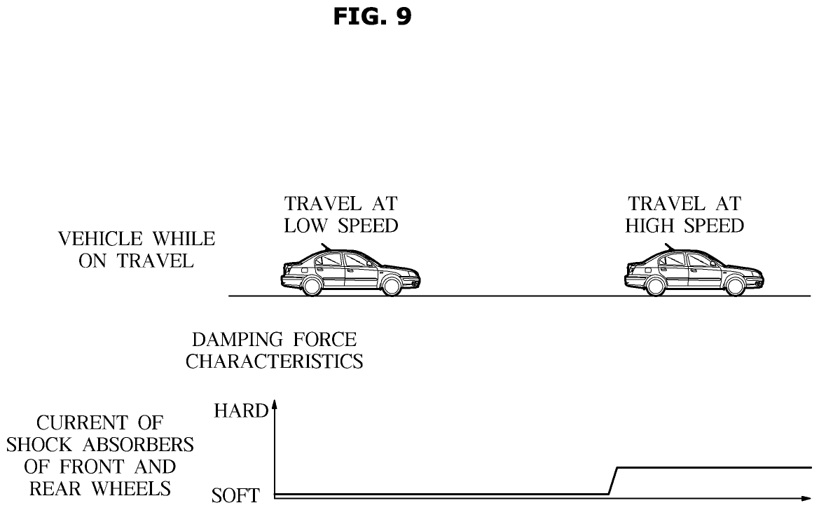

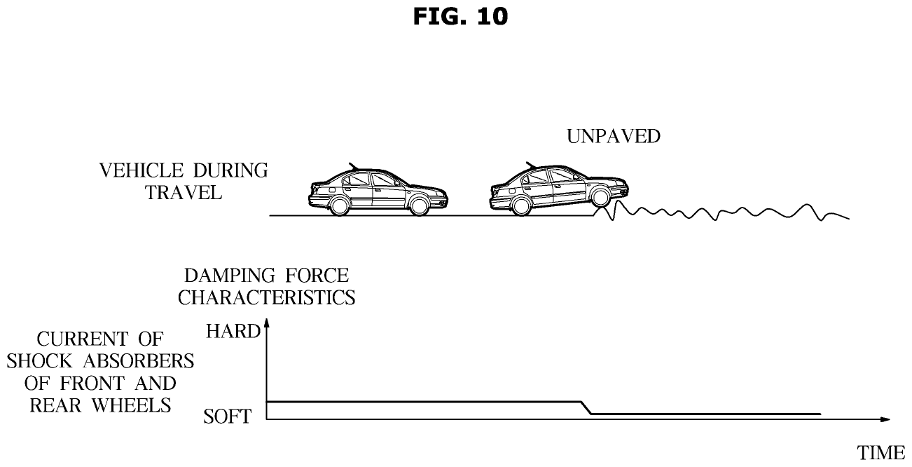

FIG. 8 is a control flowchart of a vehicle in some forms of the present disclosure, which will be described in conjunction with FIGS. 9 and 10. FIGS. 9, 10 and 11 are diagrams illustrating control of a suspension device of a vehicle in some forms of the present disclosure.

The vehicle receives detection signals detected by the plurality of detectors while traveling (201), and identifies at least one detection signal that changes in response to the state of the road surface during travel among the received detection signals detected by the plurality of detectors (202).

In addition, the detector for outputting a detection signal that changes in response to the state of the road surface during travel may be a predetermined detector.

In the identifying of detection signals that change in response to the state of the road surface during travel, the vehicle may identify a detection signal corresponding to a traveling speed of the vehicle, a detection signal corresponding to a rotational speed of each wheel, and a detection signal corresponding to a vertical acceleration of the body.

That is, the vehicle identifies detection signals output from the first detector 131 that detects a traveling speed of the vehicle, the second detector 132 for detecting the wheel speed of the wheel provided on the left side of the front of the body, the third detector 133 for detecting the wheel speed of the wheel provided on the right side of the front of the body, the fourth detector 134 for detecting the wheel speed of the wheel provided on the left side of the rear of the body, the fifth detector 135 for detecting the wheel speed of the wheel provided on the right side of the rear of the body, the sixth detector 136 detecting the vertical acceleration of the front left side of the body, and the eighth detector 138 detecting the vertical acceleration of the rear right side of the body.

Since the units for the detection signals detected by the respective detectors are different from each other, the vehicle may perform normalization control to unify the units of the detection signals. That is, the vehicle may perform signal processing on the detection signals.

The vehicle recognizes the state of the road surface using deep learning on the detection signals output from the first detector, the second detector, the third detector, the fourth detector, the fifth detector, the sixth detector, and the eight detectors (203)

In the recognizing of the state of the road surface, the vehicle identifies detection signals output from the first detector, the second detector, the third detector, the fourth detector, the fifth detector, the sixth detector, and the eighth detector at preset time intervals, and recognizes the state of the road surface at the preset intervals. The preset time interval may be approximately 10 ms.

The vehicle controls the suspension device on the basis of information about a control strategy of the suspension device for each state of the road surface stored in the storage and information about the recognized state of the road surface (204).

Referring to FIG. 9, if it is determined that the recognized state of the road surface is a state of being paved, the vehicle acquires the traveling speed of the vehicle on the basis of the detection signal output from the first detector. If the acquired traveling speed is less than or equal to a reference speed, the vehicle performs soft control on the suspension devices provided on the front, rear, left, and right wheels of the body, and if the acquired traveling speed is greater than the reference speed, the vehicle performs hard control on the suspension devices provided on the front, rear, left, and right wheels of the body.

As such, when the vehicle is traveling at a low speed, the suspension device is subject to soft control, so that riding comfort is improved, and when the vehicle is traveling at a high speed, the suspension device is subject to hard control, so that the driving stability is improved.

The performing of soft control on the suspension devices provided on the front, rear, left, and right wheels includes reducing target current values of the actuators of the shock absorbers of the suspension devices provided on the front, rear, left, and right wheels to be lowered than a reference current value.

The performing of soft control on the suspension devices provided on the front, rear, left, and right wheels includes identifying target current values corresponding to the acquired traveling speed, and allowing current corresponding to the identified target current values to flow through the actuators of the shock absorbers of the suspension device. In this case, the target current value may be smaller than the reference current value.

The performing of hard control on the suspension devices provided on the front, rear, left, and right wheels includes increasing target current values of the actuators of the shock absorbers of the suspension devices provided on the front, rear, left, and right wheels to be higher than a reference current value.

The performing of hard control on the suspension devices provided on the front, rear, left, and right wheels includes identifying target current values corresponding to the acquired traveling speed, and allowing current corresponding to the identified target current values to flow through the actuators of the shock absorbers of the suspension device. In this case, the target current value may be larger than the reference current value.

In addition, if it is determined that the recognized state of the road surface is a state of being paved, the vehicle may acquire the traveling speed of the vehicle on the basis of the detection signal output from the first detector. If the acquired traveling speed is less than or equal to a first reference speed, the vehicle may perform further soft control on the suspension devices provided on the front, rear, left, and right wheels of the body by reducing the target current values of the shock absorbers of the suspension devices provided on the front, rear, left, and right wheels of the body to be lower than the reference current value. If the acquired traveling speed is greater than a second reference speed, the vehicle may perform further hard control on the suspension devices provided on the front, rear, left, and right wheels of the body by increasing the target current values of the shock absorbers of the suspension devices provided on the front, rear, left, and right wheels of the body to be higher than the reference current value. If the acquired traveling speed is greater than the first reference speed and less than the second reference speed, the vehicle may control the suspension devices provided on the front, rear, left, and right wheels of the body such that current corresponding to the reference current value flows through the shock absorbers of the suspension devices provided on the front, rear, left, and right wheels of the body.

Referring to FIG. 10, if it is determined that the recognized state of the road surface is a state of being unpaved, the vehicle performs soft control on all of the suspension devices connected to the front, rear, left, and right wheels of the body by allowing current corresponding to a target current value lower than the reference current value to pass through the shock absorbers of the suspension devices provided on the front, rear, left, and right wheels of the body.

If it is determined that the recognized state of the road surface is a state of having a speed bump, the vehicle controls the suspension devices provided on the left and right wheels of the front of the body (i.e., the front wheels) with a damping force different from a damping force of the suspension devices provided on the left and right wheels of the rear of the body (i.e., the rear wheels). In this case, the vehicle controls the respective suspension devices with different damping forces in response to the positions of the front wheels, the rear wheels, and the speed bump.

That is, the vehicle may perform soft control on the suspension devices from the point in time at which the front wheels and the rear wheels reach the speed bump until the point in time at which the front wheels and the rear wheels are passing through the speed bump, and perform hard control on the suspension devices after the front wheels and the rear wheels pass through the speed bump.

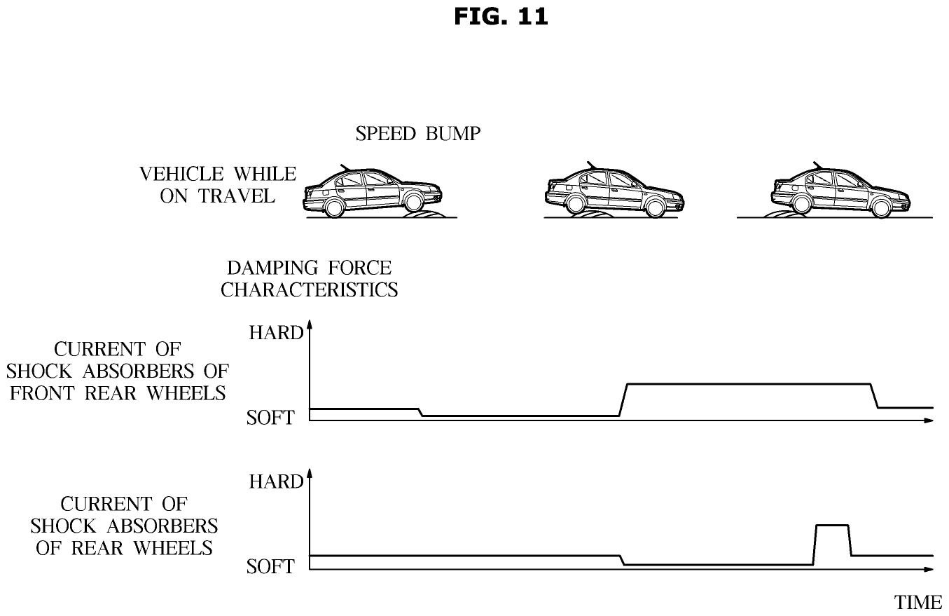

Referring to FIG. 11, the vehicle allows a current corresponding to the reference current value to flow through the suspension devices provided on the front, rear, left, and right wheels before the front wheels reach the speed bump, and if it is determined that the front wheels have reached the speed bump, performs further soft control on the suspension devices provided on the front wheels by allowing a current corresponding to a target current value lower than the reference current value to flow through the suspension devices provided on the front wheels. In this case, the vehicle allows a current corresponding to the reference current value to flow through the suspension devices provided on the rear wheels.

Thereafter, if it is determined that the front wheels have passed the speed bump and then the rear wheels have reached the speed bump, the vehicle performs hard control on the suspension devices provided on the front wheels by allowing a current corresponding to a target current value higher than the reference current value to flow through the suspension devices provided on the front wheels, and performs further soft control on the suspension devices provided on the rear wheels by allowing a current corresponding to a target current value lower than the reference current value to flow through the suspension devices provided on the rear wheels.

If it is determined that the rear wheels have passed the speed bump, the vehicle perform hard control on the suspension devices provided on the rear wheels by allowing a current corresponding to a target current value higher than the reference current value to flow through the suspension devices provided on the rear wheels. In this case, the vehicle perform hard control also on the suspension devices provided on the front wheels by allowing a current corresponding to a target current value higher than the reference current value to flow through the suspension devices provided on the front wheels.

Thereafter, if it is determined that a predetermined time has elapsed after the rear wheels have passed the speed bump, the vehicle allows a current corresponding to the reference current value to flow through the suspension devices provided on the front wheels and the rear wheels.

That is, the vehicle performs soft control in response to a rebound occurring after compression of the suspension devices provided in the front wheels during a period between the point in time when the front wheels reach the speed bump and the point in time when the front wheels completely pass through the speed bump, and then performs hard control. After the front wheels pass through the speed bump, the vehicle may predict that the rear wheels will pass through the speed bump before the rear wheels reach the speed bump, so that the vehicle may more rapidly perform soft control in response to a rebound occurring after compression of the suspension devices of the rear wheels that may occur during passing through the speed bump, and perform hard control.

Thereafter, the vehicle updates the detection information for each state of the road surface and information regarding the control strategy of the suspension devices for each state of the road surface, which are stored in the storage 150a, by storing the detection signals output from the first detector, the second detector, the third detector, the fourth detector, the fifth detector, the sixth detector, and the eighth detector, and operation information of the controlled suspension devices in the storage 150a (205).

The vehicle may update the detection information for each state of the road surface and information regarding the control strategy of the suspension devices for each state of the road surface, which are stored in the storage 150a, by storing max pooling related information acquired through a deep learning on the detection signals output from the first detector, the second detector, the third detector, the fourth detector, the fifth detector, the sixth detector, and the eighth detector, and operation information of the controlled suspension devices in the storage 150a.

Meanwhile, some forms of the present disclosure may be embodied in the form of a recording medium storing instructions executable by a computer. The instructions may be stored in the form of program code and, when executed by a processor, may generate a program module to perform the operations of some forms of the present disclosure. The recording medium may be embodied as a computer-readable recording medium.

The computer-readable recording medium includes all kinds of recording media in which instructions which may be decoded by a computer are stored, for example, a Read Only Memory (ROM), a Random Access Memory (RAM), a magnetic tape, a magnetic disk, a flash memory, an optical data storage device, and the like.

As is apparent from the above, the present disclosure can improve the ride comfort and stability by recognizing a detector in which a detection signal changes in response to a state of a road surface, recognizing the state of the road surface on the basis of the detection signal detected by the recognized detector, and controlling the damping force of the suspension device in response to the recognized state of the road surface.

The present disclosure does not require a separate model that recognizes the state of the road surface for each type of suspension device because the suspension device is controlled using state information of a road surface recognized by deep learning. That is, the road surface state recognizer according to the present disclosure can be applied to all suspension devices regardless of the types of suspension device.

The present disclosure can prevent complexity from being increased when the degree of freedom increases, and prevent a control error of the vehicle due to simplification of the model by controlling the suspension device using the state information of the road surface recognized by deep learning

As described above, the present disclosure can improve the quality and productivity of the suspension device and the vehicle equipped with the suspension device, and further can increase the user's satisfaction, improve the user's convenience and the safety of the vehicle, and secure the competitiveness of the vehicle.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A vehicle comprising:
a suspension device;
a plurality of detectors configured to detect travel state information during travel and output detection signals related to the detected travel state information;
a non transitory memory configured to store detection information and control information regarding a strategy of the suspension device for each state of a road surface; and
a processor configured to:
acquire detection information regarding a state of the road surface
recognize the state of the road surface based on the information stored in the non transitory memory and the acquired detection information; and
control the suspension device based on the recognized state of the road surface and the information stored in the non transitory memory.

2. The vehicle of claim 1, wherein the processor is further configured to:
update the information stored in the non transitory memory based on the acquired detection information, the recognized state of the road surface, and information about controlling the suspension device.

3. The vehicle of claim 1, wherein, when recognizing the state of the road surface, the processor is configured to:
identify at least one detector having a detection signal that changes in response to the state of the road surface during travel among the plurality of detectors; and
use the detection signal detected by the at least one detector.

4. The vehicle of claim 3, wherein the at least one detector further comprises:
a speed detector configured to detect a traveling speed;
a plurality of wheel speed detectors provided on respective vehicle wheels including a left wheel and a right wheel at a front end of a body and a left wheel and a right wheel at a rear end of the body, wherein each wheel speed detector of the plurality of wheel speed detectors is configured to detect a rotation speed of a corresponding one of the vehicle wheels; and
a vertical acceleration detector configured to detector a vertical acceleration of the body.

5. The vehicle of claim 4, wherein the vehicle further comprises:
a chassis processor area network (CAN) communicator configured to communicate between the detector and the processor.

6. The vehicle of claim 4, wherein the processor is configured to:
recognize the state of the road surface using deep learning; and
recognize the state of the road surface at preset time intervals.

7. The vehicle of claim 4, wherein the processor is configured to:
when the recognized state of the road surface is determined to be a state of being paved, acquire a traveling speed based on the detection signal; and
when the acquired traveling speed is less than or equal to a reference speed, perform soft control on the suspension device.

8. The vehicle of claim 4, wherein the processor is configured to:
when the recognized state of the road surface is determined to be a state of being paved, acquire a traveling speed based on the detection signal; and
when the acquired traveling speed is greater than a reference speed, perform hard control on the suspension device.

9. The vehicle of claim 4, wherein, when the recognized state of the road surface is a state having a speed bump, the processor is configured to:
perform soft control on the suspension device provided on the vehicle wheel that reaches the speed bump; and
perform hard control on the suspension device provided on the vehicle wheel that has passed through the speed bump.

10. The vehicle of claim 4, wherein, when the recognized state of the road surface is determined to be a state of being unpaved, the processor is configured to perform soft control on each of the suspension devices provided on the plurality of vehicle wheels.

11. A vehicle comprising:
a plurality of vehicle wheels provided on respective sides of front, rear, left, and right of a body;
a plurality of suspension devices each provided on a corresponding one of the plurality of vehicle wheels;
a non transitory memory configured to store a deep learning program based on a convolution neural network;
a plurality of detectors configured to detect travel state information during travel and output a detection signal related to the detected travel state information; and
a processor configured to:
identify a detection signal that changes in response to a state of a road surface among the detection signals;
use the identified detection signal as input data of the deep learning program to recognize the state of the road surface; and
control the suspension device based on the recognized state of the road surface.

12. The vehicle of claim 11, wherein the detection signal includes at least one of a detection signal related to a traveling speed, a detection signal related to a rotation speed of the plurality of vehicle wheels, or a detection signal related to a vertical acceleration of the body.

13. The vehicle of claim 11, wherein the vehicle further comprises:
a chassis processor area network (CAN) communicator configured to communicate between the detector and the processor.

14. A method of controlling a vehicle including a plurality of vehicle wheels provided on respective sides of front, rear, left, and right of a body and a plurality of suspension devices each provided on a corresponding one of the plurality of vehicle wheels, the method comprising:
identifying detection signals output through a plurality of detectors during travel;
identifying the detection signal that changes in response to a state of a road surface among the identified detection signals;
acquiring, by a processor, detection information corresponding to the state of the road surface based on the identified detection signals;
recognizing, by the processor, the state of the road surface based on detection information for each state of the road surface stored in a non transitory memory and the acquired detection information; and
controlling, by the processor, the plurality of suspension devices based on the recognized state of the road surface and information regarding a control strategy of the suspension device for each state of the road surface stored in the non transitory memory.

15. The method of claim 14, wherein acquiring the detection information corresponding to the state of the road surface comprises:
acquiring at least one of a detection signal related to a traveling speed, a detection signal related to a rotation speed of the plurality of vehicle wheels, or a detection signal related to a vertical acceleration of the body.

16. The method of claim 14, wherein controlling the plurality of suspension devices comprises:
acquiring a traveling speed based on the detection signal output from a speed detector when the recognized state of the road surface is determined to be a state of being paved;
performing soft control on the suspension device when the acquired traveling speed is less than or equal to a reference speed; and
performing hard control on the suspension device when the acquired traveling speed is greater than the reference speed.

17. The method of claim 14, wherein, when the recognized state of the road surface is a state having a speed bump, controlling the plurality of suspension devices further comprises:
performing soft control on the suspension device provided on the vehicle wheel that reaches the speed bump; and
performing hard control on the suspension device provided on the vehicle wheel that has passed through the speed bump.

18. The method of claim 14, wherein the method further comprises:
when it is determined that the vehicle wheel having passed the speed bump is the front wheel, performing soft control on the suspension device provided on the rear wheel before the rear wheel reaches the speed bump.

19. The method of claim 14, wherein controlling the plurality of suspension devices further comprises:
when the recognized state of the road surface is determined to be a state of being unpaved, performing soft control on the suspension device.

20. The method of claim 14, wherein recognizing the state of the road surface further comprises:
recognizing the state of the road surface by inputting the detection signal that changes in response to the state of the road surface as input data of a deep learning program based on a convolution neural network.
